(19) United States
(12) Patent Application Publication
(10) Pub. No.: US 2007/0059667 A1
(43) Pub. Date: Mar. 15, 2007

(54) Accessory set for the teeth the fitting of which to the teeth is easy and convenient

(76) Inventor: Dong Yun Lim, Seoul (KR)

Correspondence Address: EDWARDS & ANGELL, LLP, P.O. BOX 55874, BOSTON, MA, 02205, US

(21) Appl. No.: 11/478,700

(22) Filed: Jul. 3, 2006

(51) Int. Cl. A61C 5/08

(52) U.S. Cl. 433/219

(57) ABSTRACT

The present invention provides an accessory set for the teeth. The accessory set for the teeth includes an accessory 100 for the teeth and a customizing member 200 for user's teeth mounted on the accessory 100 for the teeth.

### BRIEF EXPLANATION OF THE DRAWINGS

FIG. 1 is a view showing the conventional accessory for the teeth;

FIG. 2 is a view showing an accessory set for the teeth according to the present invention;

FIG. 3 is a view showing the working of the accessory set for the teeth according to the present invention; and

FIGS. 4 and 5 are views showing that a decorating member is mounted on the accessory for the teeth.

### DETAILED DESCRIPTION OF THE INVENTION

### Field of the Invention

The present invention relates to an accessory set for the teeth (what is so called grills or grillz) and, more particularly, to the accessory set for the teeth the fitting of which to the teeth is easy and convenient.

### BACKGROUND

The accessory for the teeth is a kind of accessory to be worn over the front teeth and, after its fitting to the front teeth, the accessory is shown over the front teeth when the mouth is opened and the front teeth is exposed.

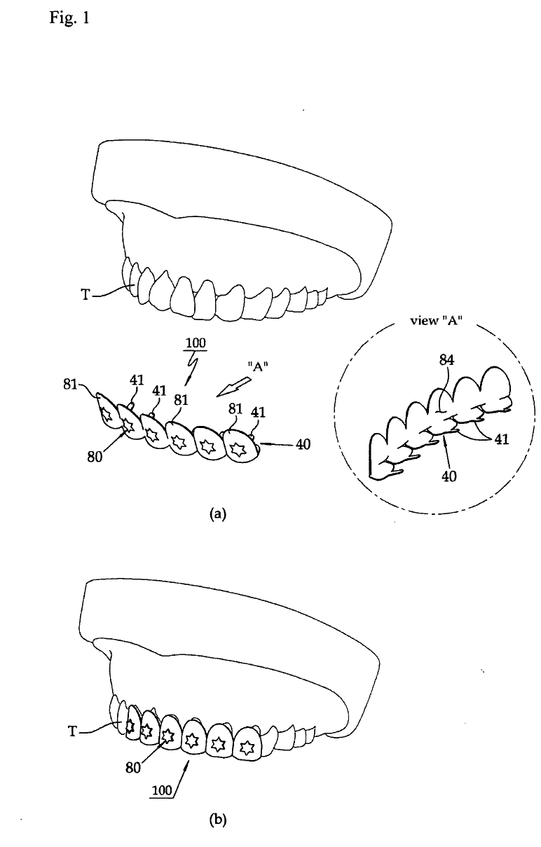

FIG. 1a shows one example of the accessory 100 for the teeth.

The accessory 100 for the teeth has an accessory plate 80 curved along the curved shape of the teeth T and the decoration such as diamond or star shape may be formed on the front of the accessory plate 80.

A bending part 40 is connected with the bottom of the accessory plate 80 and a fitting groove 84 is formed between the accessory plate 80 and the bending part 40 into which the teeth are fitted.

The accessory plate 80 may have a plurality of individual parts 81 continuously connected with each other, in this example, the upper part of the individual part 81 forms a mountain shape.

Also, the bending part 40 has a plurality of extension parts 41 extended from the bottom of the respective individual part 81 and bent in the middle thereof.

On the rear part of the mountain-shaped individual part 81, there may be a recess (not shown) corresponding to each of the tooth so that each of the tooth resides on the corresponding recess when the accessory 100 for the teeth is fitted into the front teeth through the fitting groove 84.

When used, the bending part 40 is properly bent and the accessory 100 for the teeth is fitted into the front teeth so that the front teeth is stably supported in the fitting groove 84 as shown in FIG. 1b.

Conventionally, the accessory 100 for the teeth should be customized when it is produced to make it suitable to each user's teeth, the shape and size of which is different from each other. That is, the specific shape and size of the teeth is different from each other according to the users and, accordingly, the customized production is necessary to make the accessory 100 for the teeth stably mounted on the respective user's teeth. Generally, the teeth shape is made by the plaster and then, the accessory for the teeth is made according to the plaster figure of the teeth.

The conventional accessory for the teeth is manually customized when it is produced as described above so that the production process is complicated and the relevant price becomes higher.

Accordingly, an accessory for the teeth is required which can be mounted on the teeth suitable to the shape and size of the user's teeth without the complicated production process and the higher price. In this case, it is desirable if the accessory for the teeth is convenient to wear. The present invention satisfies these requirements.

### SUMMARY OF THE INVENTION

The object of the present invention is to provide an accessory set for the teeth which is easily and conveniently mounted on the user's teeth according to the shape and size of the user's teeth.

To accomplish the object, the present invention provides an accessory set for the teeth comprising: an accessory for the teeth including an accessory plate and a bending part connected with the bottom of the accessory plate, thereby a fitting groove being formed between the accessory plate and the bending part into which the teeth are fitted; and a customizing member for user's teeth made of thermoplastics the shape of which is changeable when it is heated, the customizing member for user's teeth having a bar-shape and mounted on the fitting groove of the accessory for the teeth; whereby when the accessory for the teeth on which the customizing member for user's teeth is mounted is fitted into the user's teeth in a condition that the customizing member for user's teeth is heated and changeable in its shape, the shape of the customizing member for user's teeth become changed to fit with the user's teeth so that the accessory for the teeth is stably mounted on the user's teeth.

In the embodiment of the present invention, the accessory plate includes a plurality of individual parts continuously connected with each other and the bending part includes a plurality of extension parts each of which is extended from the bottom of the respective individual part and bent in the middle thereof.

In the embodiment of the present invention, the individual part of the accessory plate has a mountain-shape in its upper part.

In the embodiment of the present invention, the customizing member for user's teeth is curved along its length corresponding to the curved shape of the fitting groove.

According to the present invention, the respective individual part is fork-shaped and a plurality of decorating members are provided each of which has a fitting part in its rear surface to be fitted on the fork-shaped individual part.

### DETAILED DESCRIPTION OF THE PREFERRED EMBODIMENT

Now, the preferred embodiment of the present invention will be described with reference to the accompanying drawings.

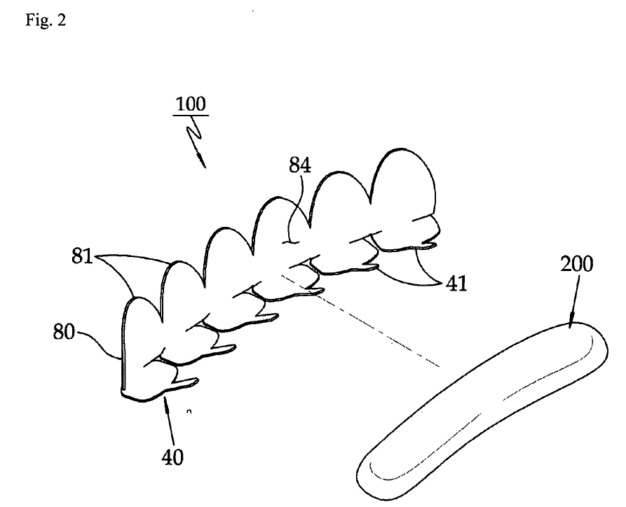

FIG. 2 shows an accessory set for the teeth according to the present invention.

The accessory set for the teeth according to the present invention includes the accessory 100 for the teeth and a customizing member 200 for user's teeth.

The customizing member 200 for user's teeth is made of thermoplastics the shape of which is changeable when it is heated and has a bar-shape. The customizing member 200 for user's teeth is mounted on the fitting groove 84 between the accessory plate 80 and the bending part 40.

In this case, the bar-shaped customizing member 200 for user's teeth may be curved along its length corresponding to the curved shape of the fitting groove 84. This curved shape of the customizing member 200 for user's teeth is desirable because it makes the customizing member 200 for user's teeth easily fitted on the fitting groove 84.

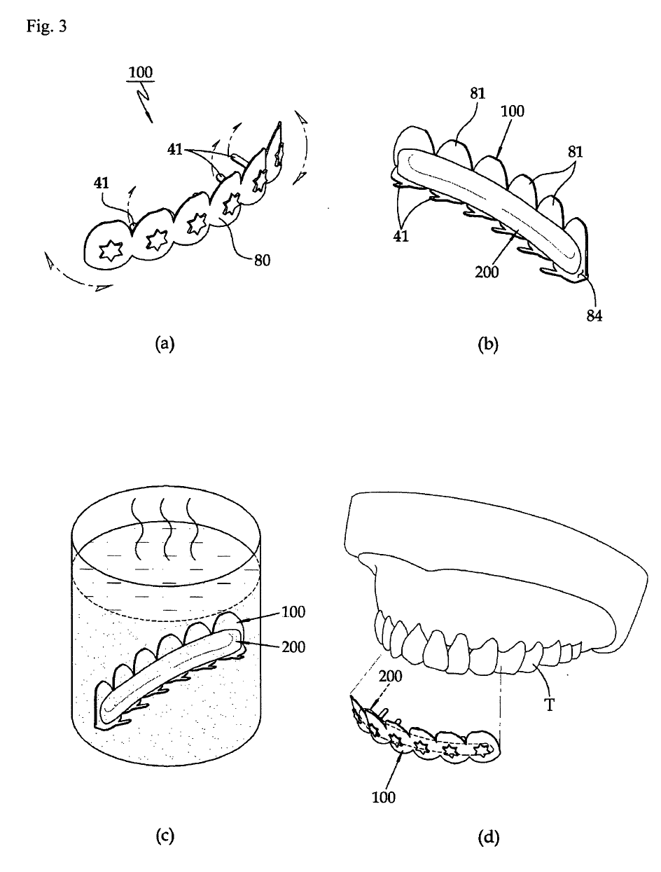

The working of the present embodiment is described with reference to FIG. 3.

Firstly, the accessory plate 80 and the bending part 40 are partially bent to conform to user's teeth. (FIG. 3(a))

Next, the customizing member 200 for user's teeth is mounted on the fitting groove 84. (FIG. 3(b))

In this state, the customizing member 200 for user's teeth is heated to reach the condition that it is changeable in its shape. For instance, the accessory 100 for the teeth on which the customizing member 200 for user's teeth is mounted is placed in the heated water to reach the condition that its shape is changeable. This example is shown in FIG. 3(c).

Then, the accessory 100 for the teeth on which the customizing member 200 for user's teeth is mounted is worn over the user's front teeth. That is, with respect to the customizing member 200 for user's teeth mounted on the fitting groove 84 of the accessory 100 for the teeth, the teeth T are fitted. (FIG. 3(d))

In this case, since the customizing member for user's teeth 200 is changeable in its shape, its shape becomes changed to fit with the user's teeth. Then, the customizing member for user's teeth 200 is cooled and hardened.

Accordingly, the customizing member 200 for the user's teeth is combined with the accessory 100 for the teeth in its fitting groove 84 and also become changed to fit with the user's teeth.

Therefore, henceforth, the user simply wears the accessory 100 over the teeth and the accessory 100 for the teeth is precisely fitted into the teeth suitable for the shape and size of the user's teeth.

In this embodiment, the customizing member 200 for the user's teeth is mounted on the accessory 100 for the teeth, and then, it is heated. However, it is also possible that the customizing member 200 for the user's teeth is firstly heated, then, is mounted on the accessory 100 for the teeth and, the accessory 100 on which the customizing member 200 for the user's teeth is mounted is worn over the user's teeth.

According to the present invention, a decorating member may be mounted on the accessory plate 80 of the accessory 100 for the teeth. For example, a plate on which specific letters (such as Grillz) or designs are formed is mounted on the accessory plate 80.

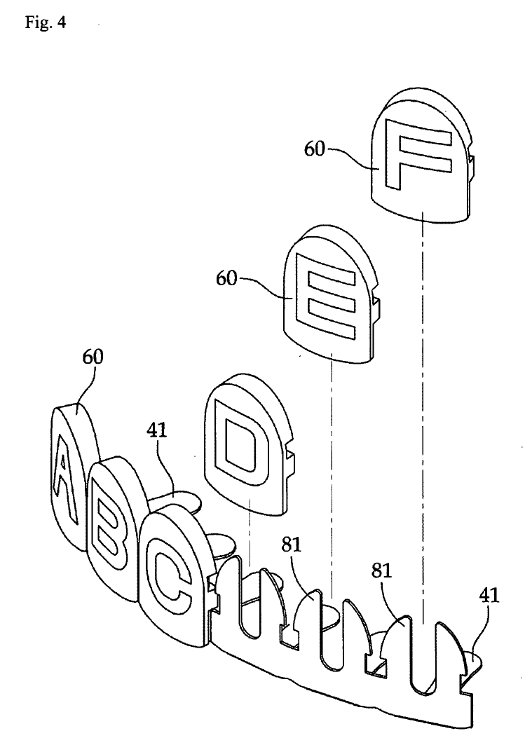

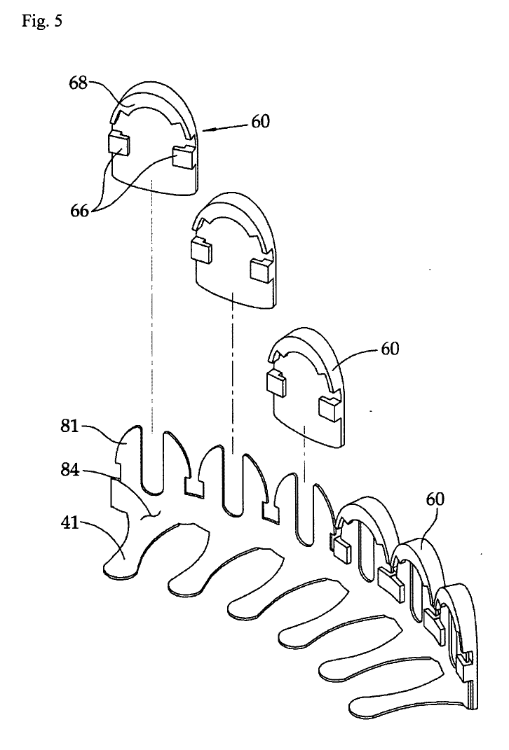

In another case, as shown in FIGS. 4 and 5, the decorating member 60 may be mounted on the each of the individual part 81 composing the accessory plate 80.

The respective individual part 81 is fork-shaped and the decorating member 60 having fitting parts 66 and 68 in its rear surface is fitted on the fork-shaped individual part 81.

In this case, for example, if alphabet character is formed on the decorating member 60, the user can select initials for his or her name and mount them on the desired individual part 81.

The Effect of the Invention

According to the present invention, the customizing member 200 for user's teeth is provided that the user can easily and conveniently mount the accessory 100 for the teeth on the teeth suitable for the shape and size of the user's teeth.

In this case, the complicated process such as making the plaster figure of the teeth is not necessary and the relevant price is largely reduced. Also, the mount of the accessory 100 for the teeth is very easy and convenient.

As described above, the present invention provides the accessory set for the teeth which can be easily and conveniently mounted on the teeth suitable to user's teeth.

Therefore, it is understood that the object of the present invention is accomplished. The present invention is described with reference to the specific embodiments, but the invention is not limited thereto. Only the following claims will determine the scope of the invention.

What is claimed is:

1. An accessory set for the teeth comprising:
(a) an accessory for the teeth including an accessory plate and a bending part connected with the bottom of the accessory plate, thereby a fitting groove being formed between the accessory plate and the bending part into which the teeth are fitted; and
(b) a customizing member for user's teeth made of thermoplastics the shape of which is changeable when it is heated, the customizing member for user's teeth having a bar-shape and mounted on the fitting groove of the accessory for the teeth; whereby (c) when the accessory for the teeth on which the customizing member for user's teeth is mounted is fitted into the user's teeth in a condition that the customizing member for user's teeth is heated and changeable in its shape, the shape of the customizing member for user's teeth become changed to fit with the user's teeth so that the accessory for the teeth is suitably mounted on the user's teeth.

2. An accessory set for the teeth as set forth in claim 1 wherein the accessory plate includes a plurality of individual parts continuously connected with each other and the bending part includes a plurality of extension parts each of which is extended from the bottom of the respective individual part and bent in the middle thereof.

3. An accessory set for the teeth as set forth in claim 1 or 2 wherein the individual part of the accessory plate has a mountain-shape in its upper part.

4. An accessory set for the teeth as set forth in claim 1 or 2 wherein the customizing member for user's teeth is curved along its length corresponding to the curved shape of the fitting groove.

5. An accessory set for the teeth as set forth in claim 1 or 2 wherein the respective individual part is fork-shaped and a plurality of decorating members are provided each of which has a fitting part in its rear surface to be fitted on the fork-shaped individual part.
